(19) United States
(12) Patent Application Publication
(10) Pub. No.: US 2017/0308603 A1
(43) Pub. Date: Oct. 26, 2017

(54) METHOD FOR CAPTURING, SHARING, AND REUSING AN EXPLORATION DEFINITION OF AN ONLINE ANALYTICAL PROCESSING CUBE

(71) Applicant: International Business Machines Corporation, Armonk, NY (US)

(72) Inventor: Sachin J. Kulkarni, Bangalore (IN)

(21) Appl. No.: 15/135,722

(22) Filed: Apr. 22, 2016

(51) Int. Cl. G06F 17/30; G06F 17/27; G06F 17/22

(52) U.S. Cl. CPC G06F 17/30592; G06F 17/30994; G06F 17/2247; G06F 17/272; G06F 17/30908

(57) ABSTRACT

A method, a computer program product, and a computer system for capturing, sharing, and reusing an exploration definition of an online analytical processing (OLAP) cube. A computer generates a document for an exploration path of an OLAP cube in a first environment, based on the exploration path on the OLAP cube generated by a user performing one or more actions. The computer generates in the document one or more segments for the at least one of arranging a view of the OLAP cube, selecting context in the OLAP cube, restricting the context, creating a custom roll-up, capturing zero suppression values, and formatting a display of the OLAP cube.

### BACKGROUND

The present invention relates generally to online analytical processing (OLAP), and more particularly to capturing, sharing, and reusing an exploration definition of an OLAP cube.

The data exploration in a large OLAP cube may be replicated in other environments. For example, when a user looks at a calculated number, if there is any aberration in the number, the owner of the data will perform OLAP gestures and slice the cube at various exploration points in many data segments before arriving at the anomaly or the point of interest. If this information needs to be replicated in other environment, the user has to re-create the exploration point across all the dimensions. Currently, there is no known method available to share the exploration view between environments.

### SUMMARY

In one aspect, a method for capturing, sharing, and reusing an exploration definition of an online analytical processing cube is provided. The method includes generating, by a computer system, a document for an exploration path of an OLAP cube in a first environment, based on the exploration path on the OLAP cube generated by a user performing one or more actions. The one or more actions comprise at least one of arranging a view of the OLAP cube, selecting context in the OLAP cube, restricting the context, creating a custom roll-up, capturing zero suppression values, and formatting a display of the OLAP cube. The method further includes generating in the document, by the computer system, one or more segments for the at least one of the arranging a view of the OLAP cube, the selecting context in the OLAP cube, the restricting the context, the creating a custom roll-up, the capturing zero suppression values, and the formatting a display of the OLAP cube.

In another aspect, a computer program product for capturing, sharing, and reusing an exploration definition of an online analytical processing cube is provided. The computer program product comprises a computer readable storage medium having program code embodied therewith. The program code is executable by a computer to generate, by a computer system, a document for an exploration path of an OLAP cube in a first environment, based on the exploration path on the OLAP cube generated by a user performing one or more actions. The one or more actions comprise at least one of arranging a view of the OLAP cube, selecting context in the OLAP cube, restricting the context, creating a custom roll-up, capturing zero suppression values, and formatting a display of the OLAP cube. The program code is further executable by the computer to generate in the document a segment for selecting context in the OLAP cube. The program code is further executable by the computer to generate in the document, by the computer system, one or more segments for the at least one of the arranging a view of the OLAP cube, the selecting context in the OLAP cube, the restricting the context, the creating a custom roll-up, the capturing zero suppression values, and the formatting a display of the OLAP cube.

In yet another aspect, a computer system for capturing, sharing, and reusing an exploration definition of an online analytical processing cube is provided. The computer system comprises one or more processors, one or more computer readable tangible storage devices, and program instructions stored on at least one of the one or more computer readable tangible storage devices for execution by at least one of the one or more processors. The program instructions are executable by a computer to generate, by a computer system, a document for an exploration path of an OLAP cube in a first environment, based on the exploration path on the OLAP cube generated by a user performing one or more actions including at least one of arranging a view of the OLAP cube, selecting context in the OLAP cube, restricting the context, creating a custom roll-up, capturing zero suppression values, and formatting a display of the OLAP cube. The program instructions are executable by a computer to generate in the document, by the computer system, one or more segments for the at least one of the arranging a view of the OLAP cube, the selecting context in the OLAP cube, the restricting the context, the creating a custom roll-up, the capturing zero suppression values, and the formatting a display of the OLAP cube.

### BRIEF DESCRIPTION OF THE SEVERAL VIEWS OF THE DRAWINGS

FIG. 1 is a diagram illustrating generating a document for an exploration path of an online analytical processing (OLAP) cube in an environment, importing the document and extracting the exploration path in another environment, in accordance with one embodiment of the present invention.

FIG. 2 is a diagram illustrating generating a document for an exploration path of an online analytical processing (OLAP) cube, parsing code in the document and applying the exploration path in another online analytical processing (OLAP) cube, in accordance with one embodiment of the present invention.

FIG. 3 is a diagram illustrating generating a document for an exploration path of an online analytical processing (OLAP) cube, sending the document to another user, in accordance with one embodiment of the present invention.

FIG. 4 is a diagram illustrating components of a computer device hosting one or more computer programs for generating a document for an exploration path of an online analytical processing (OLAP) cube in an environment and for reusing the exploration path in another environment, on another OLAP cube, or by another user, in accordance with one embodiment of the present invention.

### DETAILED DESCRIPTION

Embodiments of the present invention provide a method for creating a meta-extract of an online analytical processing (OLAP) cube's exploration view definition. In the method, the meta-exact is re-used in other environments, on a different cube in same environment, or passed on to other users. The (OLAP) cube's exploration view definition is accomplished by performing many OLAP gestures or actions, which include but not limited to follows: (1) Arranging the view: Arranging the view is accomplished by choosing an appropriate data segment required for exploration and placing the data segment in row/column and nesting in a row/column. (2) Selecting the context: Selecting the context is done by choosing one or more elements from the data segment, which are part of the exploration (but not displayed). This step is repeated for many data segments in the cube until the user arrives at the end of analysis. (3) Restricting the context: While a data segment can have several sets of elements, a user may choose to analyze on a limited set of elements. The user can therefore delete the rest of the elements for exploration. (4) Creating custom roll-ups: After restricting the elements in a data segment, a user may want to look at the aggregation of numbers. The user may therefore create custom roll-ups. (5) Zero suppression: The zero suppression can be done at a row level, a column level, or both a row level and a column level. A user may turn on or turn off the zero suppression. (6) Formatting a display: Formatting the display may include fixing the row/column height and width. A user may also set a font and its style and format the numbers.

Once the aforementioned gestures or actions are performed, a user will arrive at the desired exploration of OLAP data. Many OLAP tools allow a user to perform many of the above listed gestures or actions. However, a user faces the following challenges. (1) How to create the exact exploration in another environment? (2) If there is another OLAP cube with many of these dimensions (data segments) which are common between the two OLAP cubes, how to create the exploration with the same level of interest and depth in the data segments? (3) How to share the exploration among different users? (4) How to maintain the data security when sharing the exploration definition across environments and/or users.

Currently, there are no known methods to address these problems; therefore, users are forced to repeat the steps to create the exploration point in different environments. To create an exploration path on a second OLAP cube, users are required to start from beginning. If users want to share their exploration of the OLAP cube, then they have to repeat the steps they performed to arrive at the exploration path.

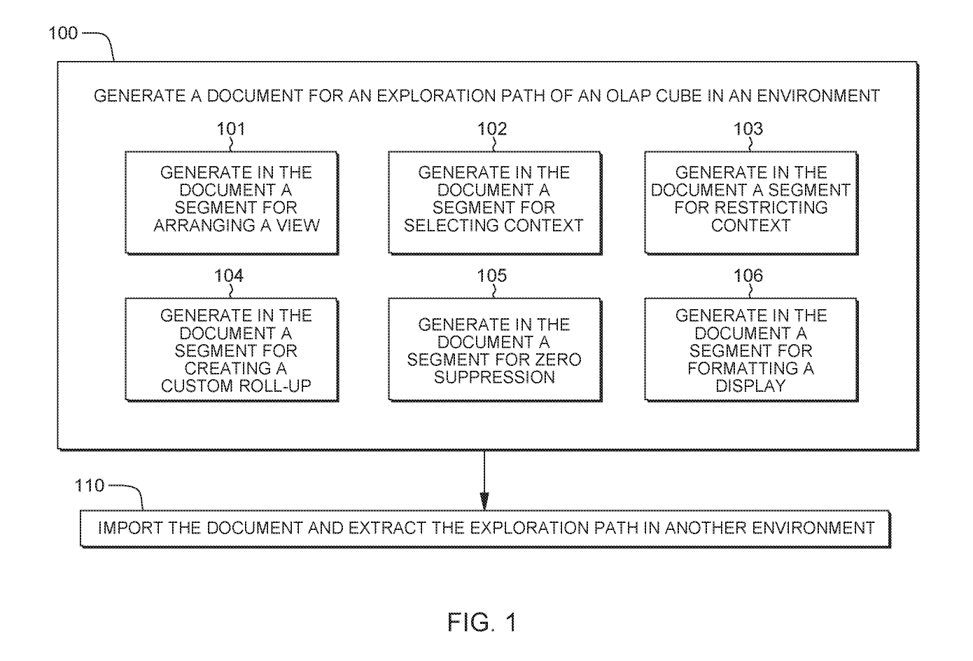

Embodiments of the present invention provide a solution addressing all of these problems. After a user performs the various OLAP gestures or actions, a computer system provides a user with an option to copy the exploration definition. The user has an option to export the exploration definition with or without formatting. Based on an exploration path on an OLAP cube generated by a user performing the various OLAP gestures or actions, a computer system generates a document for an exploration path of an OLAP cube, shown in 100 of FIG. 1. In an embodiment of the present invention, a computer system creates an XML (Extensible Markup Language) document for the exploration path. The XML document will include a combination of one or more of the aforementioned gestures or actions required to arrive at the exploration path on the OLAP cube. An embodiment of the present invention uses XML; however, other formats may also be used. The document for an exploration path for an OLAP cube may be any delimited format (such as comma separated or pipe separated). The document for an exploration path for an OLAP cube may be also a plain text file.

As shown in 101 of FIG. 1, the computer system generates a segment, which is included in the document, for arranging a view. In an embodiment of the present invention, the computer system creates an XML block tagged in the XML document. For the purpose of demonstration, here is an example. If data segments Units and Sub-Units are nested in rows and data segment Months of 2016 are in the column, then the xml block will be as follows.

<rows>

<row> Dimension:Unit

<element_01/> Sample Value 1
<element_02/> Sample Value 2
...
...

</row>
<row> Dimension:Sub-Units </row>

<element_01/> Sample Value 1
<element_02/> Sample Value 2
...
...

</row>

</rows>
<columns>

<column> Dimension:Months

<element_01/> Jan-2016
<element_02/> Feb-2016
...
...

</column>

</columns>

As shown in 102 of FIG. 1, the computer system generates a segment, which is included in the document, for selecting context. In an embodiment of the present invention, the computer system creates an XML block. For the purpose of demonstration, here is an example. The following XML code snippet is tagged in the XML document. It is worth noting that the attribute Selected will indicate the element in the data segment for which the OLAP cube value is displayed in the view.

<contexts>

<context_01>

<Dimension> Name_of_Dim </Dimension>
<Element Selected=“T”> Name_of_Element </Element>

</context_01>
<context_02>

<Dimension> Name_of_Dim </Dimension>
<Element Selected=“T”> Name_of_Element </Element>

</context_02>
...
...

</contexts>

As shown in 103 of FIG. 1, the computer system generates a segment, which is included in the document, for restricting the context. In an embodiment of the present invention, the computer system creates an XML block. For the purpose of demonstration, here is an example. In context 2 (the 2nd dimension in the context of the cube view) shown in the previous XML block for selecting context, the user has restricted 4 random elements out of 100 elements in the data segment; the following XML code snippet for restricting the context is added in the XML document. It is worth noting that the attribute Selected will indicate the element in the data segment for which the OLAP cube value is displayed in the view. While we have restricted the elements within the data segment in context 2, the last element within it used for computing the value in the view

<contexts>

<context_01>

<Dimension> Name_of_Dim </Dimension>
<Element Selected=“T”> Name_of_Element </Element>

</context_01>
<context_02>

<Dimension> Name_of_Dim </Dimension>
<Element> Name_of_first_Element </Element>
<Element> Name_of_second_Element </Element>
<Element> Name_of_third_Element </Element>
<Element Selected=“T”> Name_of_fourth_Element
</Element>

</context_02>
...
...

</contexts>

As shown in 104 of FIG. 1, the computer system generates a segment, which is included in the document, for creating a custom roll-up. In an embodiment of the present invention, the computer system creates an XML block for creating a custom roll-up in the contexts. For the purpose of demonstration, here is an example. In context 2 (the 2nd dimension in the context of the cube view) shown in the previous XML block for restricting the context, if the user creates consolidation of 2nd and 3rd elements, the following XML code snippet for creating a custom roll-up is added in the XML document.

<contexts>

<context_01>

<Dimension> Name_of_Dim </Dimension>
<Element Selected=“T”> Name_of_Element </Element>

</context_01>
<context_02>

<Dimension> Name_of_Dim </Dimension>
<Element> Name_of_first_Element </Element>
<Rollup> Rollup_Name_Defined

<Element> Name_of_second_Element </Element>
<Element> Name_of_third_Element </Element>

</Rollup>
<Element Selected=“T”> Name_of_fourth_Element
</Element>

</context_02>
...
...

</contexts>

As shown in 104 of FIG. 1, the computer system generates a segment, which is included in the document, for creating a custom roll-up. In another embodiment of the present invention, the computer system creates an XML block for creating a custom roll-up in rows and/or columns in addition to the contexts. For the purpose of demonstration, here is an example demonstrating creation of roll ups in the Unit data segment of the OLAP cube.

<rows>

<row> Dimension:Unit

<element_01/> Sample Value 1
<Rollup> Rollup_Name_Defined

<element_02/> Sample Value 2
<element_03/> Sample Value 3

</Rollup>
...
...

</row>
<row> Dimension:Sub-Units </row>

<element_01/> Sample Value 1
<element_02/> Sample Value 2
...
...

</row>

</rows>

As shown in 105 of FIG. 1, the computer system generates a segment, which is included in the document, for capturing zero suppression values. In an embodiment of the present invention, the computer system creates an XML block for capturing zero suppression values. For the purpose of demonstration, here is an example. If row suppression is turned on and column is off, the following XML code snippet is included in the XML document.

<suppression>

<row> On </row>
<column> Off </column>

</suppression>

As shown in 106 of FIG. 1, the computer system generates a segment, which is included in the document, for formatting a display. In an embodiment of the present invention, the computer system creates an XML block for capturing all attributes of the display. For the purpose of demonstration, here is an example. The following XML code snippet shows capturing one of attributes of the display.

<format>

<width>

<rows>

<row> Dimension:Unit

<height> 15px </height>
<width> 40px </width>

</row>

</rows>
<columns>
</columns>

</width>

</format>

The above-mentioned XML code snippets are for the illustration purpose. In the OLAP exportation view, once the user has selected to export the view with formatting, the XML code is generated by the computer system.

As shown in 110 of FIG. 1, the computer system imports the document for an exploration path of an OLAP cube to another environment, and the computer system extracts the exploration path in another environment.

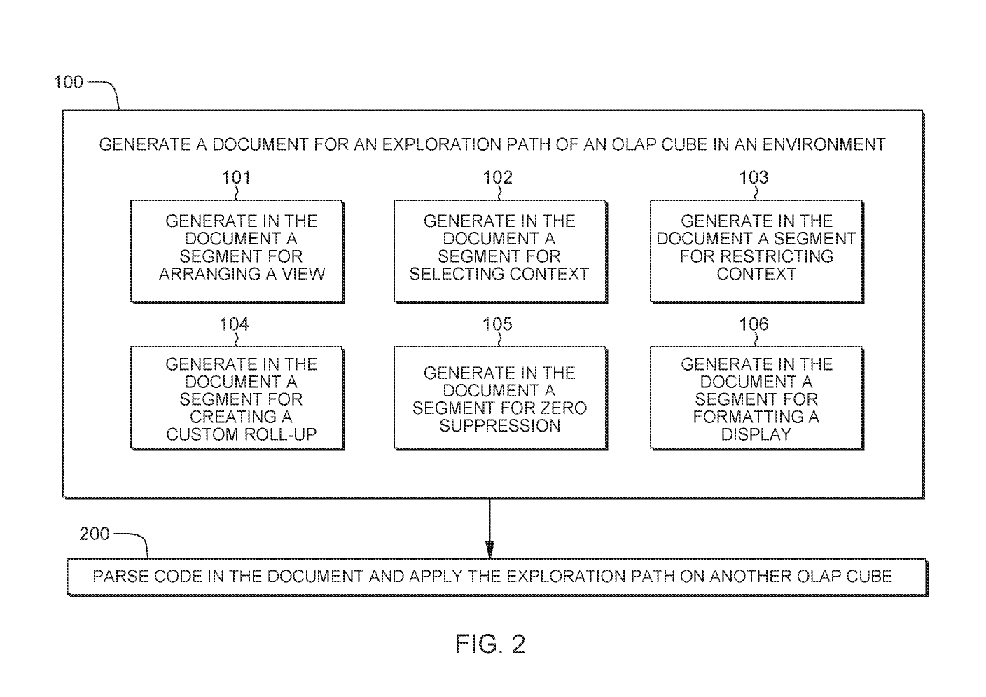

FIG. 2 is a diagram illustrating generating a document for an exploration path of an online analytical processing (OLAP) cube, parsing code in the document and applying the exploration path in another online analytical processing (OLAP) cube, in accordance with one embodiment of the present invention. A computer system generates a document for an exploration path for an OLAP cube, shown in block 100 of FIG. 2. Generating segments in the document are shown in blocks within block 100, including 101-106. Detailed descriptions of generating the document and the segments therein are given in previous paragraphs with reference to FIG. 1. As shown in block 200 of FIG. 2, a computer system parses the code in the document and extracts the exploration path on a second OLAP cube. If the dimension is applicable in the second OLAP cube, the appropriate dimension will be used. As an example, if the dimension is mentioned in a row, then the computer system will put the data segment of interest in a row of the second OLAP cube. If the dimension format is mentioned in the format tag, then appropriate format will be applied.

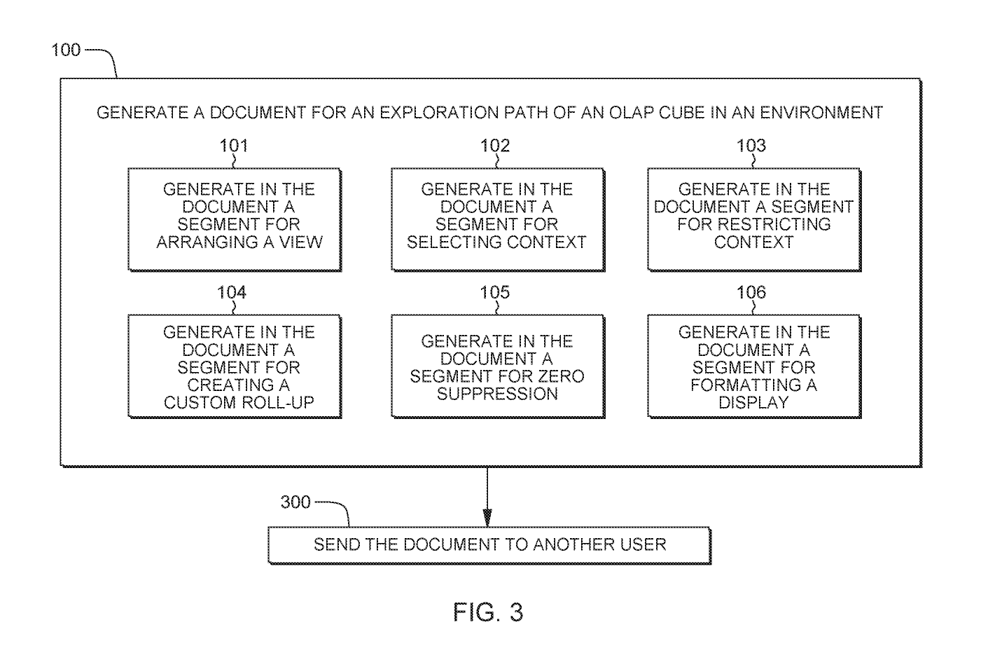

FIG. 3 is a diagram illustrating generating a document for an exploration path of an online analytical processing (OLAP) cube, sending the document to another user, in accordance with one embodiment of the present invention. A computer system generates a document for an exploration path for an OLAP cube, shown in block 100 of FIG. 2. Generating segments in the document are shown in blocks within block 100, including 101-106. Detailed descriptions of generating the document and the segments therein are given in previous paragraphs with reference to FIG. 1. As shown in block 200 of FIG. 3, a computer system sends the document for the exploration path of an OLAP cube to another user.

When the OLAP exploration view is opened by the same user in another environment, or opened by another user, the computer system will render results according to the security defined on the OLAP cube in the environment for the given user. For example, if a first user has access to elements 1, 2 and 3 from a dimension and an exploration is shared with a second user who does not have access to element 2, then the computer system will display to the second user the values of elements 1 and 3 but does not display element 2.

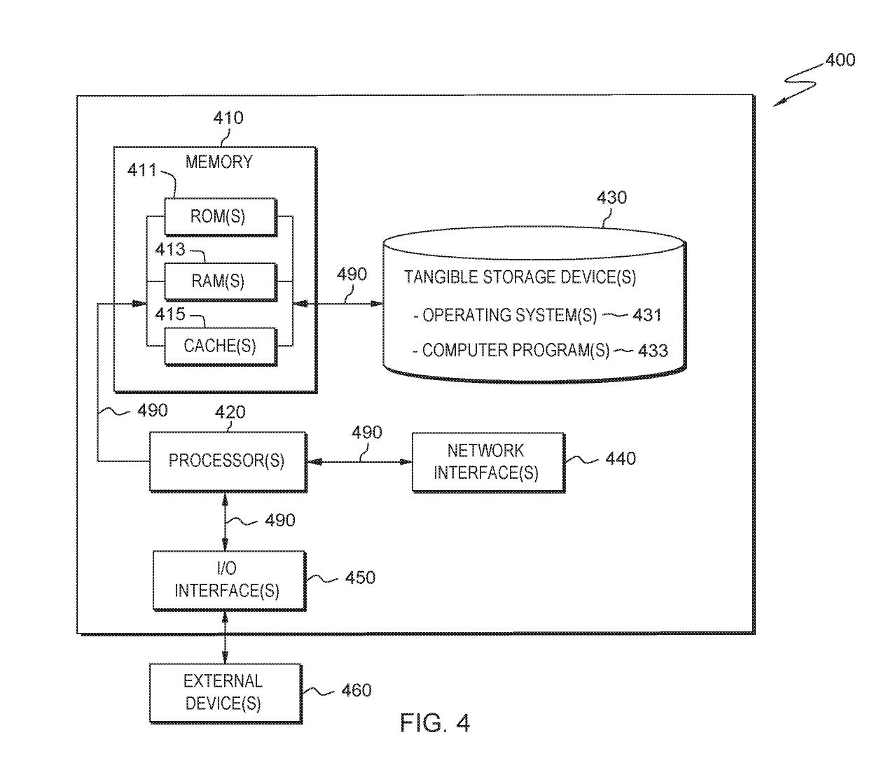

FIG. 4 is a diagram illustrating components of computer device 400 hosting one or more computer programs for generating a document for an exploration path of an online analytical processing (OLAP) cube in an environment and for reusing the exploration path in another environment, on another OLAP cube, or by another user, in accordance with one embodiment of the present invention. It should be appreciated that FIG. 4 provides only an illustration of one implementation and does not imply any limitations with regard to the environment in which different embodiments may be implemented.

Referring to FIG. 4, computer device 400 includes processor(s) 420, memory 410, and tangible storage device(s) 430. In FIG. 4, communications among the above-mentioned components of computer device 400 are denoted by numeral 490. Memory 410 includes ROM(s) (Read Only Memory) 411, RAM(s) (Random Access Memory) 413, and cache(s) 415. One or more operating systems 431 and one or more computer programs 433 reside on one or more computer readable tangible storage device(s) 430. One or more computer programs 433 include one or more computer programs for generating a document for an exploration path of an online analytical processing (OLAP) cube in an environment and for reusing the exploration path in another environment, on another OLAP cube, or by another user. Computer device 400 further includes I/O interface(s) 450. I/O interface(s) 450 allows for input and output of data with external device(s) 460 that may be connected to computer device 400. Computer device 400 further includes network interface(s) 440 for communications between computer device 400 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the FIGs illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for capturing, sharing, and reusing an exploration definition of an online analytical processing (OLAP) cube, the method comprising:
generating, by a computer system, a document for an exploration path of an OLAP cube in a first environment, based on the exploration path on the OLAP cube generated by a user performing one or more actions, wherein the one or more actions comprise at least one of arranging a view of the OLAP cube, selecting context in the OLAP cube, restricting the context, creating a custom roll-up, capturing zero suppression values, and formatting a display of the OLAP cube; and
generating in the document, by the computer system, one or more segments for the at least one of the arranging a view of the OLAP cube, the selecting context in the OLAP cube, the restricting the context, the creating a custom roll-up, the capturing zero suppression values, and the formatting a display of the OLAP cube.

2. The method of claim 1, further comprising:
importing to a second environment, by the computer system, the document for the exploration path of the OLAP cube in the first environment; and
extracting, by the computer system, the exploration path in the second environment.

3. The method of claim 1, further comprising:
generating, by a computer system, the document for the exploration path of a first OLAP cube;
parsing, by the computer system, code in the document for the exploration path of the first OLAP cube; and
applying, by the computer system, the exploration path on a second OLAP cube.

4. The method of claim 1, wherein the document for the exploration path of the OLAP cube is sent to another user.

5. The method of claim 1, wherein the document for the exploration path of the OLAP cube is an XML (Extensible Markup Language) document.

6. The method of claim 1, wherein the document for the exploration path of the OLAP cube is delimited format file or a plain text file.

7. A computer program product for capturing, sharing, and reusing an exploration definition of an online analytical processing (OLAP) cube, the computer program product comprising a computer readable storage medium having program code embodied therewith, the program code executable to:
generate, by a computer system, a document for an exploration path of an OLAP cube in a first environment, based on the exploration path on the OLAP cube generated by a user performing one or more actions, wherein the one or more actions comprise at least one of arranging a view of the OLAP cube, selecting context in the OLAP cube, restricting the context, creating a custom roll-up, capturing zero suppression values, and formatting a display of the OLAP cube; and
generate in the document, by the computer system, one or more segments for the at least one of the arranging a view of the OLAP cube, the selecting context in the OLAP cube, the restricting the context, the creating a custom roll-up, the capturing zero suppression values, and the formatting a display of the OLAP cube.

8. The computer program product of claim 7, further comprising the program code executable to:
import to a second environment, by the computer system, the document for the exploration path of the OLAP cube in the first environment; and
extract, by the computer system, the exploration path in the second environment.

9. The computer program product of claim 7, further comprising the program code executable to:
generate, by a computer system, the document for the exploration path of a first OLAP cube;
parse, by the computer system, code in the document for the exploration path of the first OLAP cube; and
apply, by the computer system, the exploration path on a second OLAP cube.

10. The computer program product of claim 7, wherein the document for the exploration path of the OLAP cube is sent to another user.

11. The computer program product of claim 7, wherein the document for the exploration path of the OLAP cube is an XML (Extensible Markup Language) document.

12. The computer program product of claim 7, wherein the document for the exploration path of the OLAP cube is delimited format file or a plain text file.

13. A computer system for capturing, sharing, and reusing an exploration definition of an online analytical processing (OLAP) cube, the computer system comprising:
one or more processors, one or more computer readable tangible storage devices, and program instructions stored on at least one of the one or more computer readable tangible storage devices for execution by at least one of the one or more processors, the program instructions executable to:
generate, by a computer system, a document for an exploration path of an OLAP cube in a first environment, based on the exploration path on the OLAP cube generated by a user performing one or more actions, wherein the one or more actions comprise at least one of arranging a view of the OLAP cube, selecting context in the OLAP cube, restricting the context, creating a custom roll-up, capturing zero suppression values, and formatting a display of the OLAP cube; and
generate in the document, by the computer system, one or more segments for the at least one of the arranging a view of the OLAP cube, the selecting context in the OLAP cube, the restricting the context, the creating a custom roll-up, the capturing zero suppression values, and the formatting a display of the OLAP cube.

14. The computer system of claim 13, further comprising the program instructions executable to:
import to a second environment, by the computer system, the document for the exploration path of the OLAP cube in the first environment; and
extract, by the computer system, the exploration path in the second environment.

15. The computer system of claim 13, further comprising the program instructions executable to:
generate, by a computer system, the document for the exploration path of a first OLAP cube;
parse, by the computer system, code in the document for the exploration path of the first OLAP cube; and
apply, by the computer system, the exploration path on a second OLAP cube.

16. The computer system of claim 13, wherein the document for the exploration path of the OLAP cube is sent to another user.

17. The computer system of claim 13, wherein the document for the exploration path of the OLAP cube is an XML (Extensible Markup Language) document.

18. The computer system of claim 13, wherein the document for the exploration path of the OLAP cube is delimited format file or a plain text file.
